(19) United States
(12) Patent Application Publication
(10) Pub. No.: US 2008/0055270 A1
(43) Pub. Date: Mar. 6, 2008

(54) TOUCH SCREEN DISPLAY HAVING TOUCH PANEL, AND METHOD OF MANUFACTURE

(76) Inventors: Jong-Whan Cho, Gyeonggi-do (KR); Seong-Chul Hong, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/849,838

(22) Filed: Sep. 4, 2007

(30) Foreign Application Priority Data
Sep. 5, 2006 (KR) 2006-85148

(51) Int. Cl. G06F 3/041

(52) U.S. Cl. 345/173

(57) ABSTRACT

A resistive type touch panel includes an upper substrate, a lower substrate, and a porous polymer. The upper substrate has a first electrode. The lower substrate has a second electrode facing the first electrode. The porous polymer layer is disposed between the first electrode and the second electrode to increase uniformity of distance between the first electrode and the second electrode. The porous polymer layer has a plurality of openings. The first electrode and the second electrode are electrically connected to each other through the porous polymer layer when an external object makes contact with the resistive type touch panel.

### CROSS-REFERENCE TO RELATED APPLICATIONS

The present application claims priority under 35 U.S.C. § 119 to Korean Patent Application No. 2006-85148, filed on Sep. 5, 2006 in the Korean Intellectual Property Office (KIPO), the contents of which are herein incorporated by reference in their entirety.

### BACKGROUND OF THE INVENTION

1. Field of the Invention

The present invention relates to a touch screen display apparatus. More particularly, the present invention relates to a resistive type touch panel, a touch screen display apparatus having the resistive type touch screen panel and a method of manufacturing the resistive type touch panel.

2. Description of the Related Art

Touch panels are disposed on some types of flat panel displays (FPDs) and are used as input devices. A touch panel may be classified as an optical type, a surface wave type using ultrasonic waves, a resistive type, or a capacitive type, etc. The resistive type touch panel is widely used in a portable terminal because of its thinness, light weight, etc. The resistive type touch panel is used in a public place such as a railroad station or a library because of its mechanical ruggedness and in the navigational systems of automobiles because of its resistance to vibrations. A resistive type touch panel is most commonly used in a liquid crystal display (LCD) apparatus because of the requirement for thinness, small size, and light weight. However, when the touch panel is disposed on the LCD apparatus, the thickness of display apparatus becomes larger and the distance between the electrodes in the touch panel becomes irregular. As a result, the optical characteristics of the LCD apparatus are adversely affected.

The hybrid type touch screen panel (hTSP) addresses these concerns by integrating the touch panel into the LCD panel but this makes the manufacturing processes complex.

When the touch screen panel is applied to a display apparatus to form a dual mode display apparatus, which displays images using one light assembly and one panel, the thickness of the dual mode display apparatus and manufacturing costs are increased, and optical characteristics of the display apparatus are affected.

### SUMMARY OF THE INVENTION

A resistive type touch panel in accordance with one aspect of the present invention includes an upper substrate and a lower substrate each having a respective electrode. A porous polymer layer having a plurality of openings is disposed between the two electrodes to increase the uniformity of the distance between the electrodes. The first electrode and the second electrode are electrically connected to each other through the porous polymer layer when an external object makes contact with the resistive type touch panel.

The openings in the polymer may be randomly or uniformly formed. For example, the width of an opening may range from about 0.1 μm to about 500 μm and the thickness of the porous polymer layer may range from about 0.1 μm to about 500 μm. The resistive type touch panel may further include a touch panel control part detecting coordinates based on coordinate signals of a contact point. The coordinate signals of the contact point may be generated from the first electrode and the second electrode.

A resistive type screen display apparatus in accordance with another aspect of the present invention includes a display panel part, a light source, and a resistive touch panel part. The display panel part displays at least one image. The light source part faces the display panel part and provides the display panel with light to display the image. The resistive touch panel part includes a first electrode, a second electrode, and a porous polymer layer. The first electrode faces the display panel part. The second electrode faces the first electrode. The porous polymer layer is disposed between the first electrode and the second electrode to increase uniformity of a distance between the first electrode and the second electrode. The porous polymer layer has a plurality of openings. The first electrode and the second electrode are electrically connected to each other through the porous polymer layer when an external object makes contact with the resistive touch panel part.

The display panel part may display at least one image in two ways. The at least one image may include a first image and a second image. The display panel part may include a transmissive pixel and a reflective pixel. The transmissive pixel transmits light to provide light to display the second image. The reflective pixel reflects light to provide light to display the first image. The first image and the second image may be substantially the same or different from each other.

In order to display images in two ways, a display panel part may include an array substrate having a reflective pixel and a transmissive pixel, a counter substrate facing the reflective pixel and the transmissive pixel and a liquid crystal layer interposed between the array substrate and the counter substrate. A light source part may include a light source providing light and a light-guide plate. The light-guide plate faces the counter substrate and guides light to the counter substrate.

A first electrode may be formed on a rear surface of the array substrate or on the light-guide plate. When the first electrode is formed on the rear surface of the array substrate, the touch panel part may further include a first polarizer having a second electrode disposed at a side facing the first electrode. The display panel part may further include a second polarizer disposed between the counter substrate and the light-guide plate. When the first electrode is formed on the light-guide plate, the touch panel part may further include a first polarizer having the second electrode disposed at a side facing the first electrode. The display panel part may further include a second polarizer disposed on the rear surface of the array substrate.

A method of manufacturing a touch screen display apparatus in accordance with one aspect of the present invention is provided as follows. A resistive touch panel part having a first electrode, a second electrode facing the first electrode, and a porous polymer layer is formed on a rear surface of an array substrate having a plurality of unit pixels. The polymer layer is disposed between the first and second electrodes and increases the uniformity of distance between the first and second electrodes. The array substrate and a counter substrate having a common electrode facing the unit pixels are assembled together. A liquid crystal layer is formed between the array substrate and the counter substrate. A light source part is combined with the counter substrate.

When the touch panel part is formed, the first electrode may be further formed on a rear surface of the array substrate. The porous polymer layer may be further formed on the first electrode or the second electrode, and a first polarizer having the second electrode may be combined with the array substrate.

According to the resistive type touch panel, the touch screen display apparatus having the resistive type touch screen panel and the method of manufacturing the resistive type touch panel, display quality may be enhanced while the thickness of the touch screen display apparatus may be reduced.

### BRIEF DESCRIPTION OF THE DRAWINGS

The above and other advantages of the present invention will become readily apparent by reference to the following detailed description when considered in conjunction with the accompanying drawings, in which:

FIG. 1 is an exploded perspective view illustrating a touch panel in accordance with a first exemplary embodiment of the present invention;

FIG. 2 is a plan view illustrating the lower substrate in FIG. 1;

FIG. 3 is a cross-sectional view taken along a line I-I′ in FIG. 1;

FIG. 4 is a plan view illustrating a touch panel in accordance with a second exemplary embodiment of the present invention;

FIG. 5 is a cross-sectional view taken along a line II-II′ in FIG. 4;

FIG. 6 is an exploded perspective view illustrating the touch screen display apparatus in accordance with a third exemplary embodiment of the present invention;

FIG. 7 is a cross-sectional view taken along a line III-III′ in FIG. 6;

FIG. 8 is a plan view illustrating the array substrate in FIG. 6;

FIG. 9 is a lateral view illustrating the touch screen display apparatus in FIG. 6;

FIG. 10 is an exploded perspective view illustrating a touch screen display apparatus in accordance with a fourth exemplary embodiment of the present invention;

FIG. 11 is a cross-sectional view taken along a line IV-IV′ in FIG. 10;

FIG. 12 is a lateral view illustrating the touch screen display apparatus in FIG. 10;

FIGS. 13 and 14 are perspective views illustrating a method of manufacturing a touch screen display apparatus in accordance with a fifth exemplary embodiment of the present invention;

FIG. 15 is a perspective view illustrating a method of manufacturing a touch screen display apparatus in accordance with a sixth exemplary embodiment of the present invention;

FIG. 16 is a perspective view illustrating a method of manufacturing a touch screen display apparatus in accordance with a seventh exemplary embodiment of the present invention; and

FIG. 17 is a perspective view illustrating a method of manufacturing a touch screen display apparatus in accordance with a eighth exemplary embodiment of the present invention.

### DESCRIPTION OF THE EMBODIMENTS

In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

### Resistive Type Touch Panel

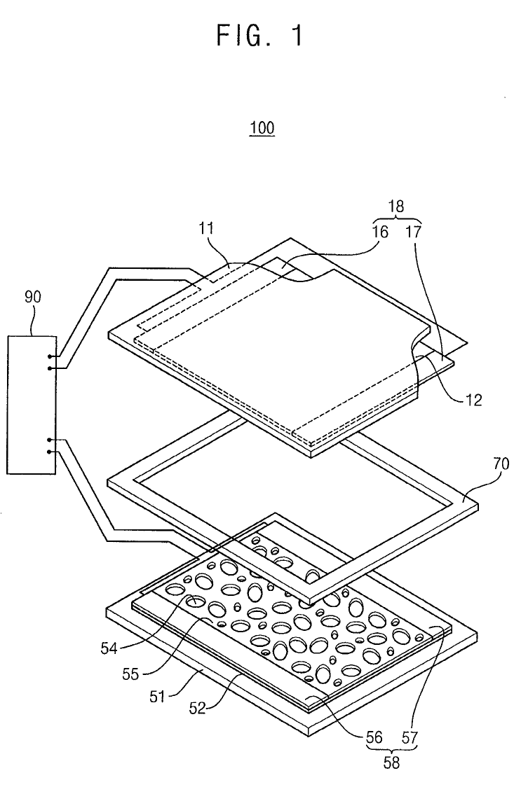

FIG. 1 is an exploded perspective view illustrating a touch panel in accordance with a first exemplary embodiment of the present invention.

Referring to FIG. 1, a resistive type touch panel (hereinafter referred to as “touch panel”) 100 includes an upper substrate 11, a lower substrate 51 and a porous polymer layer 55. The lower substrate 51 is spaced apart from the upper substrate 11 by a predetermined distance, and faces the upper substrate 11. When a user touches a desired point on the touch panel 100 two facing, conductive layers are electrically connected to each other at a contact point corresponding to the desired point. The resistance at the contact point changes the level of a voltage applied to the conductive layers, and a controlling part computes the coordinates of the contact point according to the voltage change.

The upper substrate 11 and the lower substrate 51 may be fabricated of a material having good optical transmissivity, thermal resistance, chemical resistance, and mechanical strength. The upper substrate 11 may include a transparent film such as polymethyl methacrylate, a glass substrate, a plastic substrate, etc. The lower substrate 51 may include a transparent film such as polymethyl methacrylate, a glass substrate, a plastic substrate, etc. Examples of the plastic substrate may include polymethyl methacrylate, polyimide, polypropylene, polyurethane, etc. These can be used alone or in a combination.

A first electrode 12 as a conductive layer is disposed in a display area of the upper substrate 11. A second electrode 52 is disposed in a display area of the lower substrate 51. The second electrode 52 faces the first electrode 12. For example, the first electrode 12 and the second electrode 52 may include a transparent conductive material such as indium tin oxide (ITO), indium zinc oxide (IZO), etc. In the present exemplary embodiment, the first electrode 12 and the second electrode 52 are uniformly formed over the whole display area. In another exemplary embodiment, the first electrode 12 and the second electrode 52 may have a predetermined pattern, for example, a stripe pattern.

The touch panel 100 may further include an X-electrode bar 18 and a Y-electrode bar 58. The X-electrode bar 18 is connected to opposite side portions of the first electrode 12 and applies a voltage to the first electrode 12 in a horizontal direction. The Y-electrode bar 58 is connected to opposite side portions of the second electrode 52 and applies a voltage to the second electrode 52 in a vertical direction.

The X-electrode bar 18 includes a first X-electrode bar 16 receiving a driving voltage and a second X-electrode bar 17 receiving a ground voltage. The Y-electrode bar 58 includes a first Y-electrode bar 56 receiving a driving voltage and a second Y-electrode bar 57 receiving a ground voltage.

The porous polymer layer 55 is disposed between the first electrode 12 and the second electrode 52. The porous polymer layer 55 increases uniformity of the distance between the first electrode 12 and the second electrode 52 according to various positions. In other words, the porous polymer layer 55 may serve as a spacer maintaining the distance between the first electrode 12 and the second electrode 52. Thus, the porous polymer layer 55 may be disposed on the second electrode 52 and make contact with the second electrode 52.

The porous polymer layer 55 may have various characteristics such as a polymer having good heat resistance, chemical resistance, electrical insulation properties, and elasticity. For example, the porous polymer layer 55 may include a thin polyurethane film having a plurality of openings 54.

The porous polymer layer 55 may be disposed on a surface of the first electrode 12 or a surface of the second electrode 52. In the present exemplary embodiment, the porous polymer layer 55 is disposed on an area of the second electrode 52 except for an area that the Y-electrode bar 58 covers. For example, the porous polymer layer 55 may be disposed on the surface of the second electrode 52, or may be disposed on the second electrode 52 as a film.

The touch panel 100 may further include an adhesive member 70. The adhesive member 70 is disposed at the non-display area and adheres the upper substrate 11 to the lower substrate 51. Thus, the upper substrate 11 and the lower substrate 51 are separated from each other by the thickness of the adhesive member 70.

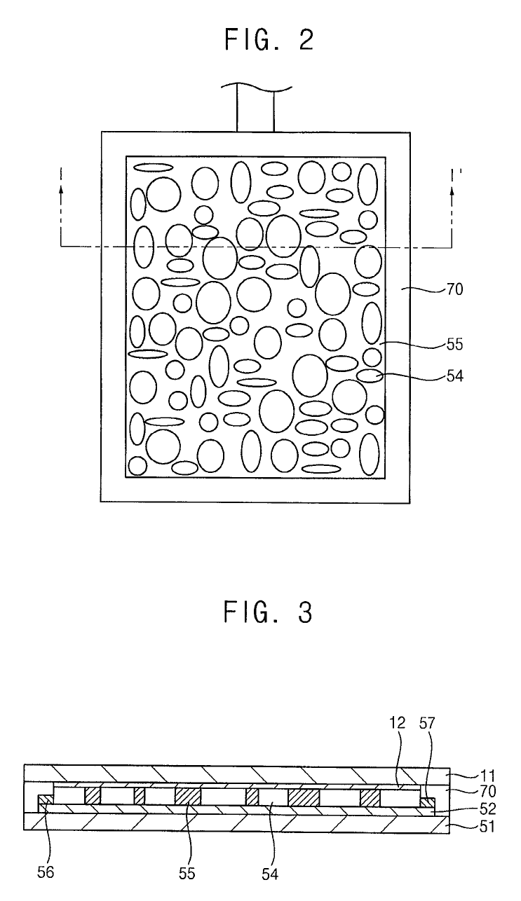

FIG. 2 is a plan view illustrating the lower substrate in FIG. 1. FIG. 3 is a cross-sectional view taken along a line I-I′ in FIG. 1.

Referring to FIGS. 2 and 3, the openings 54 of the porous polymer layer 55 may be randomly or uniformly formed according to the desired manufacturing process. In FIG. 2, the openings 54 have random positions and random sizes.

When an external object such as a finger or a pen compresses the upper substrate 11, the first electrode 12 and the second electrode 52 make contact with each other through the openings 54 of the porous polymer layer 55.

In order to prevent incomplete contact of the first electrode 12 and the second electrode 52 at any position, each of the openings 54 has a width ranging from about 0.1 μm to about 500 μm. The openings 54 may have high density. The thickness of the porous polymer layer 55 has a range from about 1 μm to about 500 μm so as to obtain high touch sensitivity. The porous polymer layer 55 advantageously has the form of a thin film of uniform thickness throughout the display area of the touch panel 100.

When the touch panel 100 having a conventional column spacer disposed on the surface of the first electrode 12 or the surface of the second electrode 52 to maintain the distance between the first electrode 12 and the second electrode 52, the column spacer may be destroyed or worn out after long usage making the distance between the first electrode 12 and the second electrode 52 non-uniform. As a result, the surface of the touch panel 100 displaying images may become irregular and a Newton ring phenomenon may occur adversely affecting display quality and the sensitivity of the touch panel 100.

In the present exemplary embodiment, the uniformity of the distance between the first electrode 12 and the second electrode 52 is increased by the porous polymer layer 55. The porous polymer layer 55 has a thin-film shape and includes polymer having good resiliency. Thus, in spite of long time use of the touch panel 100, uniformity of the surface of the touch panel 100 may be maintained.

The touch panel 100 may further include a touch panel controlling part 90. The touch panel controlling part 90 applies driving voltages to the first X-electrode bar 16 and the first Y-electrode bar 56 and applies ground voltages to the second X-electrode bar 17 and the second Y-electrode bar 57. The touch panel controlling part 90 detects coordinates based on coordinate signals of the contact point. The coordinate signals of the contact point are provided from the first electrode 12 and the second electrode 52. The touch panel controlling part 90 transmits the coordinates to a display apparatus such as a liquid crystal display (LCD) apparatus.

The present invention is not limited to the touch panel 100 that is described above in the present exemplary embodiment but may be applied to various resistive type touch panels having the porous polymer layer 55 serving as a spacer between electrodes.

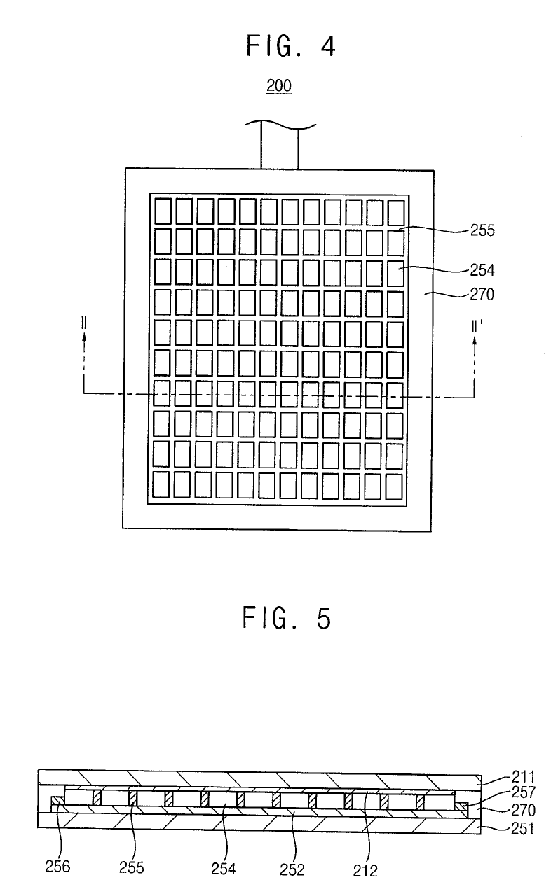

FIG. 4 is a plan view illustrating a touch panel in accordance with a second exemplary embodiment of the present invention. FIG. 5 is a cross-sectional view taken along a line II-II′ in FIG. 4.

Referring FIGS. 4 and 5, a touch panel 200 includes an upper substrate 211, a lower substrate 251 facing the upper substrate 211, a porous polymer layer 255 and an adhesive member 270. The touch panel 200 is substantially the same as the touch panel 200 illustrated in FIGS. 2 and 3 except for the porous polymer layer 255. Thus, any further explanation concerning the above elements will be omitted.

In the present exemplary embodiment, the porous polymer layer 255 includes a plurality of openings 254 having a regular pattern. In FIG. 4, each of the openings 254 has a quadrangular shape and is arranged in a matrix shape. Alternatively, the openings may have a circular shape or a polygonal shape, and the openings 254 may have various shapes.

The width of the openings 254 may range from about 0.1 μm to about 500 μm, and the pitch of the openings 254 may range from about 0.1 μm to about 500 μm, in order that the first electrode 212 and the second electrode 252 make contact with each other at any position. Also, a thickness of the porous polymer layer 255 ranges from about 1 μm to about 500 μm.

In the present exemplary embodiment, since the openings 254 have the regular pattern through the porous polymer layer 255, as illustrated in FIG. 5, a location at which the first electrode 212 and the second electrode 252 make contact with each other is spatially uniform. Thus, the uniformity of the distance between the first electrode 212 and the second electrode 252 is increased, and sensitivity of the touch panel 200 is spatially uniform.

### Touch Panel Display Apparatus

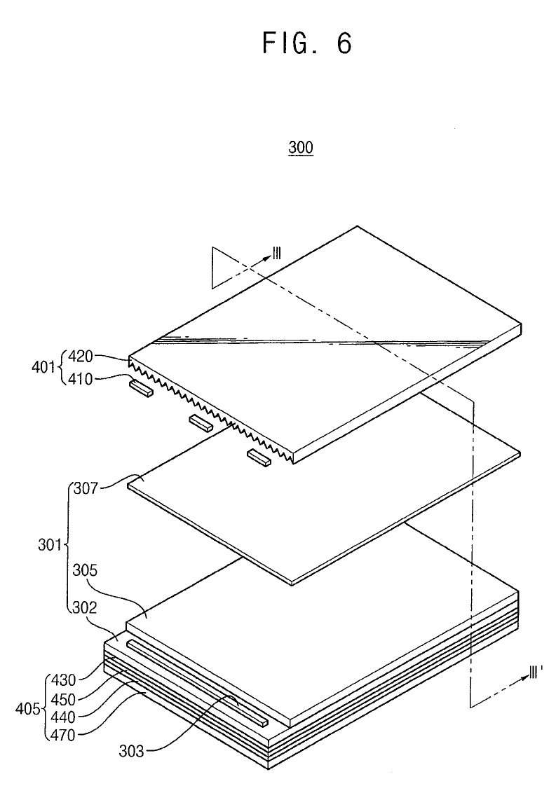

FIG. 6 is an exploded perspective view illustrating a touch screen display apparatus in accordance with a third exemplary embodiment of the present invention.

Referring to FIG. 6, a touch screen display apparatus 300 includes a display panel part 301, a light source part 410, and a touch panel part 405. The touch screen display apparatus 300 displays images in one way or two ways. In the present exemplary embodiment, the touch screen display apparatus 300 displays images in two ways.

In order to display images in two ways, the display panel part 301 includes a reflective pixel and a transmissive pixel. The reflective pixel and the transmissive pixel define first and second unit pixels, respectively. The transmissive pixel transmits incident light to generate light for displaying a first image. The reflective pixel reflects incident light so that a second image is displayed using the reflected light.

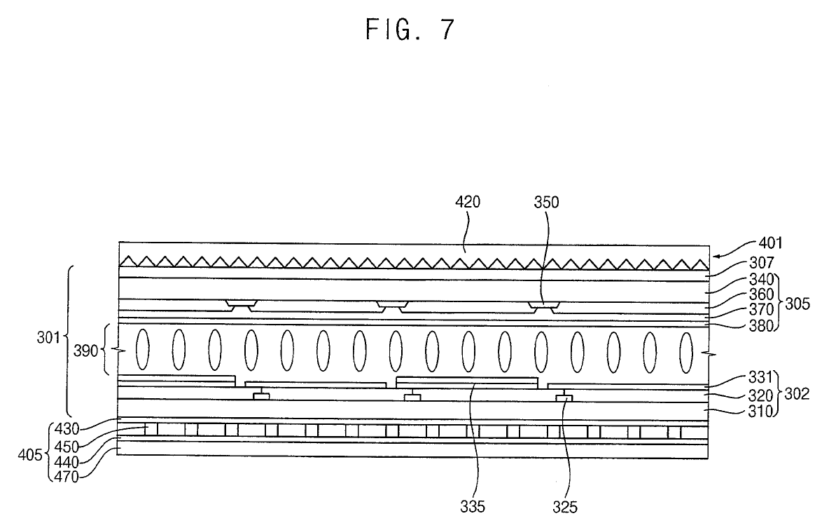

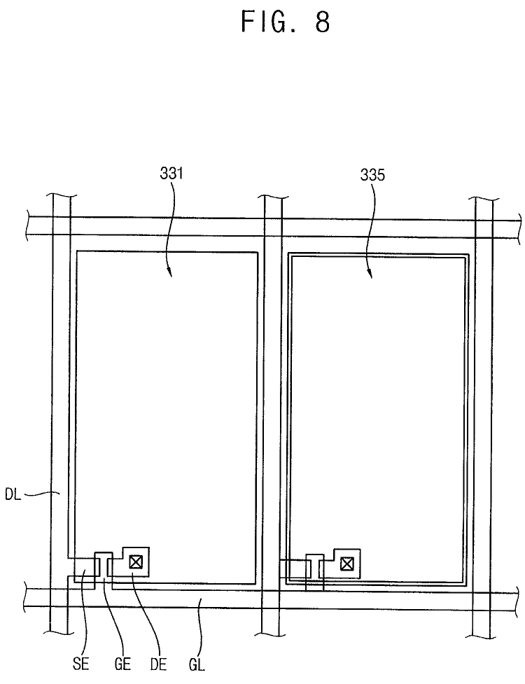

FIG. 7 is a cross-sectional view taken along a line III-III′ in FIG. 6. FIG. 8 is a plan view illustrating the array substrate in FIG. 6.

Referring to FIGS. 7 and 8, a display panel part 301 includes an array substrate 302 having a reflective pixel and a transmissive pixel, a counter substrate 305 facing the reflective pixel and the transmissive pixel, and a liquid crystal layer 390 disposed between the array substrate 302 and the counter substrate 305. The display panel part 301 displays images in two ways.

For example, the array substrate 302 includes a lower base substrate 310, a thin-film transistor (TFT) layer 320, a reflective pixel 335, and a transmissive pixel 331.

The lower base substrate 310 may include an optically isotropic glass substrate. The TFT layer 320 may include switching devices and wirings applying a pixel voltage to the reflective pixel 335 and the transmissive pixel 331. The wirings include data lines DL and gate lines GL. The data lines DL receive the pixel voltage. The gate lines receive gate signals controlling the switching devices. The data lines DL and the gate lines GL are electrically insulated from each other by a gate insulating film, and intersect each other.

A unit pixel area is defined by the gate lines GL and the data lines DL. One of the reflective pixel 335 and the transmissive pixel 331 is disposed in the unit pixel area. The reflective pixel 335 and the transmissive pixel 331 independently receive the pixel voltage. Thus, a first image displayed by the light having passed through the transmissive pixel 331 may be different from the second image displayed by the light reflected from the reflective pixel 335.

In another exemplary embodiment, the reflective pixel 335 and the transmissive pixel 331 may be disposed in one unit pixel. The reflective pixel 335 and the transmissive pixel 331 are electrically connected to each other and receive a same pixel voltage. Thus, the first image and the second image may be the same.

The switching device 325 includes a source electrode electrically connected to the data lines DL, a gate electrode electrically connected to the gate lines GL and a drain electrode electrically connected to the reflective pixel 335 or the transmissive pixel 331.

The reflective pixel 335 and the transmissive pixel 331 are disposed in one unit pixel area on the TFT layer 320. The reflective pixel 335 and the transmissive pixel 331 may be alternately disposed along one line. Alternatively, the reflective pixel 335 and the transmissive pixel 331 may be disposed according to a predetermined pattern. The reflective pixel 335 may include a metal thin film having excellent optical reflectivity such as aluminum. Examples of a transparent conductive material that can be used for the transmissive pixel 331 may include indium tin oxide (ITO), indium zinc oxide (IZO), etc.

The array substrate 302 may further include a driving part 303 outputting a pixel voltage and a gate signal. The driving part 303 may have a chip shape and may be disposed in a non-display area of the array substrate 302.

The counter substrate 305 includes an upper base substrate 340 facing the lower base substrate 310, a light-blocking pattern 350, a color filter part 360, a protective film 370, and a common electrode 380.

The upper substrate 340 may include a glass substrate. The light-blocking pattern 350 corresponds to the gate lines GL and the data lines DL, and is disposed on the upper base substrate 340 in a matrix configuration. The light-blocking pattern 350 may include a metal, such as chromium, or an organic material.

The color filter part 360 may include red, green, and blue color filters. The color filters correspond to the unit pixel area and are disposed between a plurality of light-blocking patterns 350. The protective film 370 covers the color filter part 360 and protects the color filter part 360. The common electrode 380 may include a transparent conductive material and is entirely disposed on the protective film 370.

The liquid crystal layer 390 is disposed between the array substrate 302 and the counter substrate 305. Liquid crystal molecules of the liquid crystal layer 390 are rearranged by electric fields formed between the common electrode 380 and the transmissive pixel .331 and between the common electrode 380 and the reflective pixel 335, thereby controlling optical transmissivity of the liquid crystal layer 390.

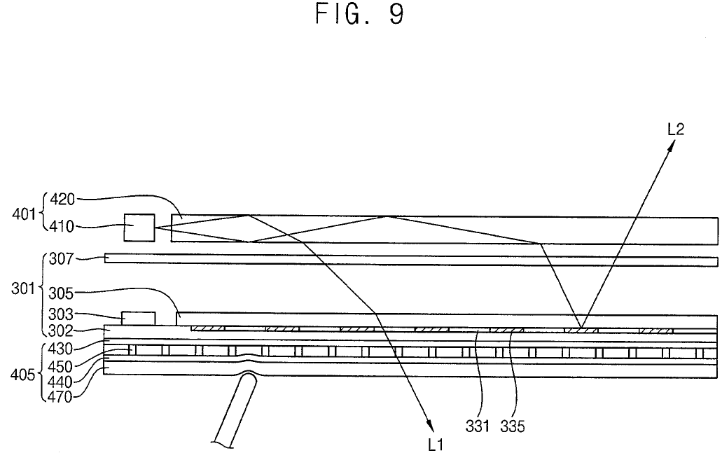

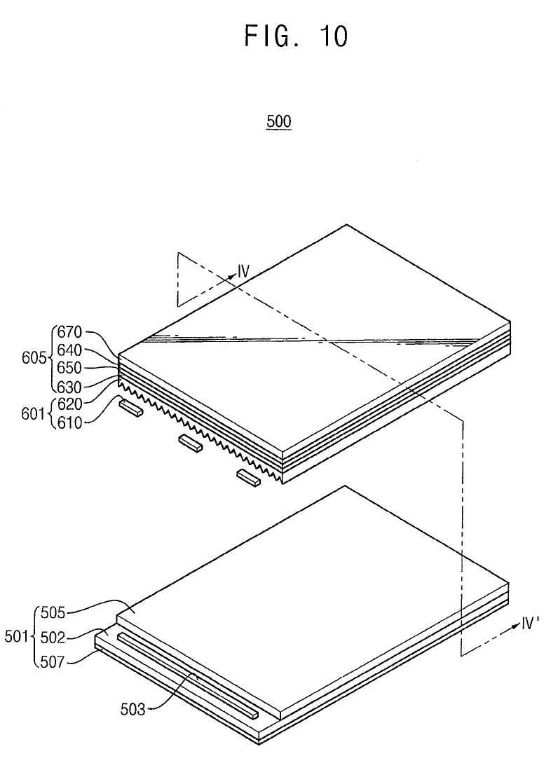

FIG. 9 is a lateral view illustrating the touch screen display apparatus in FIG. 6.

Referring to FIGS. 6 and 9, a light source part 401 faces the display panel part 301, and provides the display panel part 301 with light for displaying a first image. In the present exemplary embodiment, the light source part 401 is disposed on the counter substrate 305. The touch screen display apparatus 300 displays a color image in two ways by using a light ray L1 having passed through the transmissive pixel 331 through the color filter part 360 and a light ray L2 reflected from the reflective pixel 335.

In the present exemplary embodiment, when the light source part 401 is disposed on a rear surface of the array substrate 302, light generated from the light source part 401 to have passed through the transmissive pixel 331 and light reflected from the reflective pixel 335 exit the counter substrate 305. Thus, the touch screen display apparatus 300 displays a color image in one way.

Referring to FIG. 9, the light source part 401 includes a light source 410 and a light-guide plate 420. The light source 410 is disposed at a lateral side of the light-guide plate 420. The light source 410 may be a point light source or a fluorescent lamp, etc. The light-guide plate 420 is disposed on the counter substrate 305 and guides light generated from the light source 410 toward the counter substrate 305. For example, the light-guide plate 420 includes a light-scattering material having various characteristics such as good light transmissivity, heat resistance, chemical resistance and mechanical strength, etc. Examples of the light-scattering material that can be used for the light-guide plate 420 include polymethyl methacrylate, polyamide, polyimide, polypropylene and polyurethane, etc.

A prism pattern for enhancing front brightness of emitted light may be formed at one surface of the light-guide plate 420 facing the counter substrate 305. The prism pattern may alternatively be formed at an opposite surface to the one surface of the light-guide plate 420.

The touch screen display apparatus 300 may further include an optical sheet enhancing optical properties of the light. The optical sheet may be disposed between the light-guide plate 420 and the counter substrate 305.

The touch panel part 405 is disposed on a rear surface of the array substrate 302. The touch panel part 405 may serve as an input device for inputting information into the touch screen display apparatus 300. The touch panel part 405 may be formed through a resistive method. When two conductive layers facing each other make contact with each other, the level of a voltage is changed based on coordinates of the finger or the object. In the resistive method, the voltage change may be sensed and the coordinates may be detected.

The touch panel part 405 includes a first electrode 430, a second electrode 440, and a porous polymer layer 450. The first electrode 430 is disposed on a rear surface of the array substrate 302. The first electrode 430 may include a transparent conductive material substantially the same as that of the common electrode 380. The second electrode 440 may include substantially the same material as the first electrode 430 and be spaced apart from the first electrode 430. The first electrode 430 and the second electrode 440 face each other.

The touch panel part 405 may further include a first polarizer 470 having the second electrode 440. The porous polymer layer 450 may be disposed between the first electrode 430 and the second electrode 440 and increase uniformity of a distance between the first electrode 430 and the second electrode 440. The porous polymer layer 450 may be substantially the same as that in FIGS. 1 to 3.

The touch panel part 405 may be substantially the same as the touch panel 100 in FIGS. 1 to 3, except that the array substrate 302 substitutes for the upper substrate 11 and the first polarizer 470 substitutes for the lower substrate 51. The touch panel controlling part 90 in FIG. 1 may be connected to the driving part 303 disposed on the array substrate 302.

The display panel part 301 may further include a second polarizer 307 disposed between the light-guide plate 420 and the counter substrate 305. The first polarizer 470 and the second polarizer 307 may be disposed in crossed Nicol prisms. Alternatively, the polarization axes of the first polarizer 470 and the second polarizer 307 may be substantially parallel with each other. The polarization axes of the first polarizer 470 and the second polarizer 307 may also form an acute angle.

In the present exemplary embodiment, the touch panel part 405 includes a porous polymer layer 450 in order to increase the uniformity of the distance between the first electrode 430 and the second electrode 440. As a result, a first image using a light having passed through the transmissive pixel 331 is not optically distorted by the occurrence of the Newton ring phenomenon, and display quality is enhanced. Also, since the touch panel part 405 uses the array substrate 302 as an upper substrate, a thinner touch screen display apparatus is achieved.

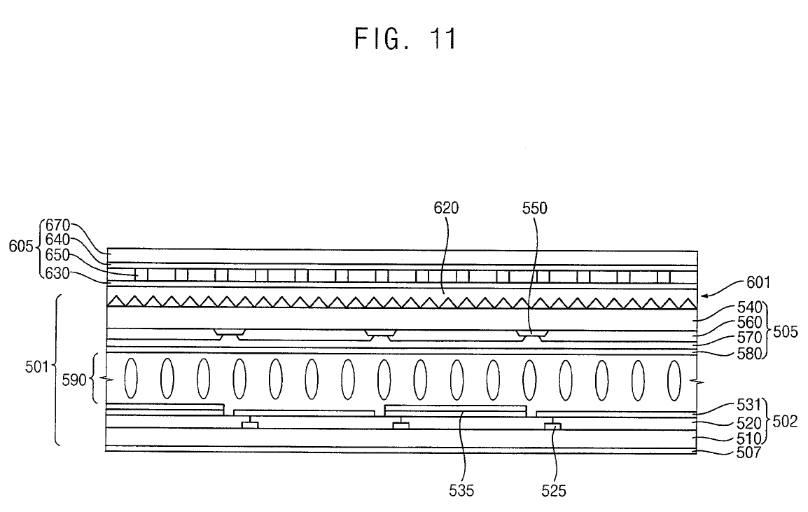

FIG. 10 is an exploded perspective view illustrating a touch screen display apparatus in accordance with a fourth exemplary embodiment of the present invention and FIG. 11 is a cross-sectional view taken along a line IV-IV′ in FIG. 10.

Referring to FIG. 10 and FIG. 11, a touch screen display apparatus 500 includes a display panel part 501, a light source part 601, and a touch panel part 605. The touch screen display apparatus 500 is substantially the same as the touch screen display apparatus 300 in FIGS. 6 to 9 except for the position of the touch panel part 605. Thus, any further explanation concerning the above elements will be omitted.

The display panel part 501 includes an array substrate 502 having a reflective pixel 535 and a transmissive pixel 531, a counter substrate 505 having a common electrode 580 and a color filter part 560, and a liquid crystal layer 590. The light source part 601 includes a light-guide plate 620 disposed on the counter substrate 505 and a light source 610 disposed at a side of the light-guide plate 620.

In the present exemplary embodiment, the touch panel part 605 is disposed on the light-guide plate 620. The touch panel part 605 may include a first electrode 630, a second electrode 640, and a porous polymer layer 650. The first electrode 630 is disposed on the light-guide plate 620.

The touch panel part 605 may further include a first polarizer 670 having the second electrode 640. The first electrode 630 and the second electrode 640 are spaced apart from each other at a predetermined distance. The porous polymer layer 650 may be disposed between the first electrode 630 and the second electrode 640. In another exemplary embodiment, the first polarizer 670 may be disposed on the light source 601, and thus reflection of external light is decreased so that contrast ratio is increased, thereby improving image display quality.

The touch panel part 605 is substantially the same as the touch panel 100 in FIGS. 1 to 3, except that the first polarizer 670 of the touch panel part 605 is substituted for the upper substrate 11 of the touch panel 100 in FIGS. 1 to 3 and the light-guide plate 620 of the touch panel part 605 is substituted for the lower substrate 51 of the touch panel 100 in FIG. 1, FIG. 2 and FIG. 3.

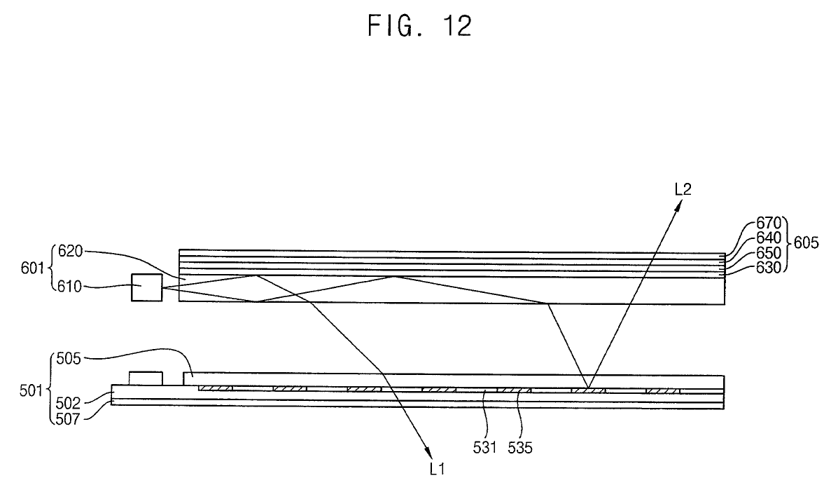

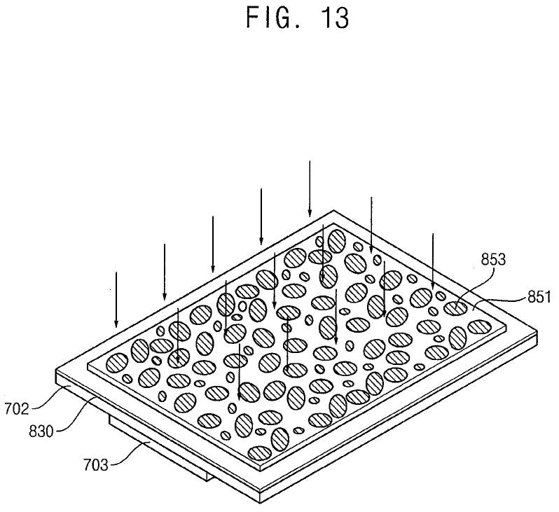

FIG. 12 is a lateral view illustrating the touch screen display apparatus in FIG. 10.

Referring to FIG. 12, light generated from the light source 610 exits toward the counter substrate 505 through the light-guide plate 620. The light may include a first light ray L1 and a second light ray L2. The first light ray L1 passes through the color filter part 560 disposed on the counter substrate 505 and through the transmissive pixel 531. The second light ray L2 is reflected from the reflective pixel 535 and exits through the color filter part 560. The touch screen display apparatus 500 displays a first image using the first light ray L1 and a second image using the second light ray L2. The second image is displayed on the touch panel part 605. The user may input commands by touching a predetermined point at which the second image is displayed.

### Method of Manufacturing a Display Apparatus

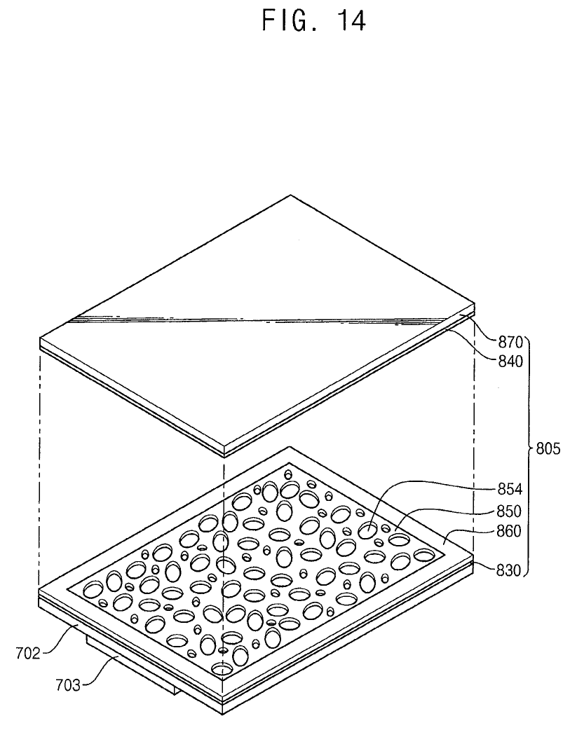

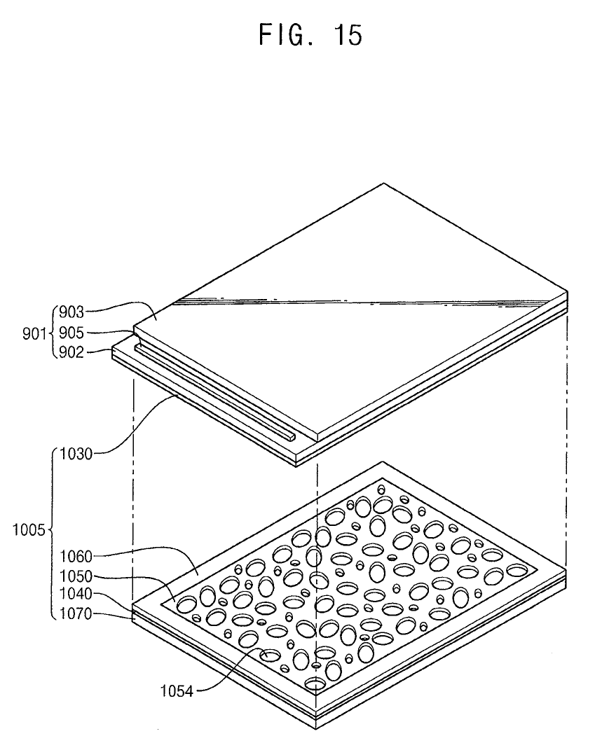

FIGS. 13 and 14 are perspective views illustrating a method of manufacturing a touch screen display apparatus in accordance with a fifth exemplary embodiment of the present invention.

Referring FIGS. 13 and 14, a method of manufacturing a touch screen display apparatus is provided as follows. A touch panel part 805 is formed on a rear surface of an array substrate 702 having a plurality of unit pixels. A counter substrate having a common electrode facing the unit pixels is combined with the array substrate 702. A liquid crystal layer is formed between the array substrate 702 and the counter substrate. A light source part is combined with the counter substrate.

A transparent conductive material is deposited on the rear surface of the array substrate 702 by a chemical vapor deposition (CVD) method to form a first electrode 830. Also, wirings electrically connecting the first electrode 830 and a driving part 703 are formed.

A polymer layer is formed on the first electrode 830. The polymer layer may include a base film 851 and a particle 853 for forming an opening 854. The particle 853 is used as a basis for forming the opening 854. An etchant melting the particle 853 without affecting the base film 851 is sprayed, and the particle 853 is melted to be removed. As a result, as illustrated in FIG. 14, the openings 854 are formed though the polymer layer to form a porous polymer layer 850.

In another exemplary embodiment, a porous polymer layer having the openings 854 may be formed on the first electrode 830. The openings 854 of the porous polymer layer may be formed through various methods.

Thereafter, an adhesive member 860 is formed on a non-display area.

A transparent conductive material is formed on one surface of the first polarizer to form a second electrode 840. The first polarizer 870 having the second electrode 840 is attached to the rear surface of the array substrate 702 to form a touch panel part 805.

The array substrate 702 and the counter substrate are combined with each other, and a liquid crystal layer is formed between the array substrate and the counter substrate, thereby forming a display panel part. The method of manufacturing a touch screen display apparatus may further include combining a second polarizer with the counter substrate.

Finally, a light source part having a light source and a light-guide plate is combined with the counter substrate to complete the touch screen display apparatus.

FIG. 15 is a perspective view illustrating a method of manufacturing a touch screen display apparatus in accordance with a sixth exemplary embodiment of the present invention.

Referring to, FIG. 15, a method of manufacturing a touch screen display apparatus is provided as follows. A touch panel part 1005 is formed on a rear surface of an array substrate 902 having a plurality of unit pixels. The array substrate 902 and a counter substrate 903 having a common electrode facing the unit pixels are combined with each other. A liquid crystal layer is formed between the array substrate and the counter substrate 903. A light source is formed on the counter substrate.

In the present exemplary embodiment, a method of manufacturing a touch screen display apparatus is substantially the same as that in FIGS. 13 and 14 except that a porous polymer layer 1050 is formed on a second electrode 1040 disposed at a first polarizer 1070 to contact with a first electrode 1030 disposed on a rear surface of the array substrate 902.

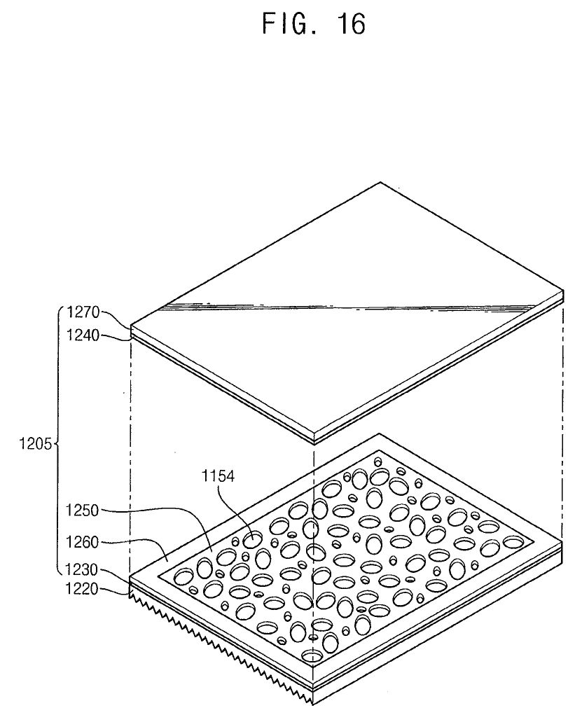

FIG. 16 is a perspective view illustrating a method of manufacturing a touch screen display apparatus in accordance with a seventh exemplary embodiment of the present invention.

Referring to FIG. 16, a touch panel part 1205 is formed on a light-guide plate 1220, and a display panel part is combined with the light-guide plate 1220.

A transparent conductive material is deposited on the light-guide plate 1220 to form a first electrode 1230. A porous polymer layer 1250 is formed on the first electrode 1230. A method of forming the porous polymer layer 1250 may be substantially the same as the method of forming the porous polymer layer 850 in FIGS. 13 and 14. Thus, any further explanation concerning the above elements will be omitted.

A second electrode 1240 is formed on one surface of the first polarizer 1270. The first polarizer 1270 having the second electrode 1240 is combined with the light-guide plate 1220 to form a touch panel part 1205.

A display panel part including an array substrate, a counter substrate, and a liquid crystal layer is combined with the touch panel part 1205 on a rear surface of the light-guide plate 1220 to complete a touch screen display apparatus.

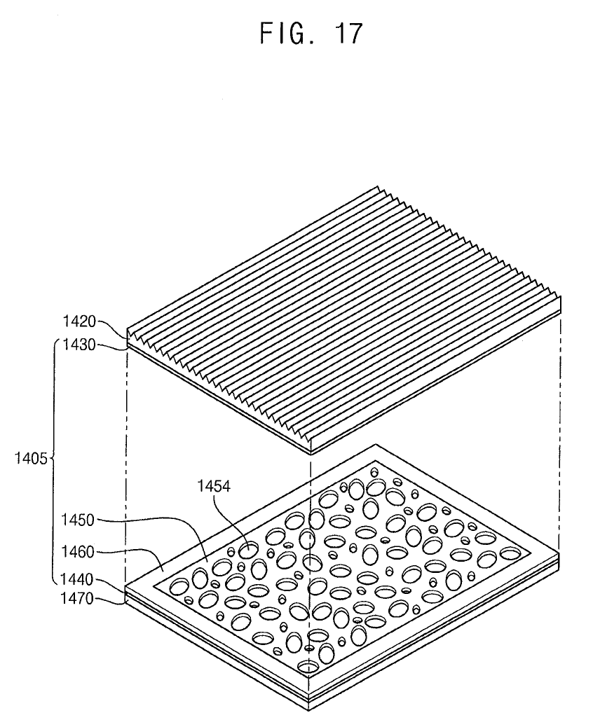

FIG. 17 is a perspective view illustrating a method of manufacturing a touch screen display apparatus in accordance with an eighth exemplary embodiment of the present invention.

Referring to FIG. 17, a touch panel part 1405 is formed on a first polarizer 1470, and a display panel part is combined with a light-guide plate 1420.

A method of manufacturing a touch screen display apparatus in the present exemplary embodiment is substantially the same as that in FIG. 16 except that a porous polymer layer 1450 is formed on a second electrode 1440 disposed on a first polarizer 1470 to contact a first electrode disposed on a light-guide plate 1420. Thus, any further explanation concerning the above elements will be omitted.

According to the present invention, a porous polymer layer may be used as a spacer of a touch panel part. Thus, uniformity of a distance between electrodes facing each other in the touch panel part is increased. As a result, display quality displayed through the touch panel part may be enhanced.

Also, an array substrate or a light-guide plate may be used as a lower substrate having a first electrode of a touch panel part. A polarizer may be used as an upper substrate having a second electrode. Thus, the thickness of the touch screen display apparatus may be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A resistive type touch panel comprising:
an upper substrate having a first electrode;
a lower substrate having a second electrode facing the first electrode; and
a porous polymer layer disposed between the first electrode and the second electrode to increase the uniformity of distance between the first electrode and the second electrode, the porous polymer layer having a plurality of openings, the first electrode and the second electrode being electrically connected to each other through the porous polymer layer when an external object makes contact with the resistive type touch panel.

2. The resistive type touch panel of claim 1, wherein the openings are randomly formed through the porous polymer layer.

3. The resistive type touch panel of claim 1, wherein the openings are arranged in a matrix configuration and the porous polymer layer has a net shape.

4. The resistive type touch panel of claim 1, wherein the width of each of the openings ranges from about 0.1 μm to about 500 μm.

5. The resistive type touch panel of claim 1, wherein the thickness of the porous polymer layer ranges from about 0.1 μm to about 500 μm.

6. The resistive type touch panel of claim 1, further comprising a touch panel control part detecting coordinates based on coordinate signals of a contact point, the coordinate signals of the contact point being generated from the first electrode and the second electrode.

7. A resistive type screen display apparatus comprising:
a display panel part for displaying an image;
a light source part facing the display panel part and providing the display panel part with light to display the image; and
a resistive touch panel part including:
a first electrode facing the display panel part;
a second electrode facing the first electrode; and
a porous polymer layer disposed between the first electrode and the second electrode to increase uniformity of distance between the first electrode and the second electrode, the porous polymer layer having a plurality of openings, the first electrode and the second electrode being electrically connected to each other through the porous polymer layer when an external object makes contact with the resistive touch panel part.

8. The resistive type screen display apparatus of claim 7, wherein the image comprises a first image and a second image, and the display panel part includes:
a reflective pixel reflecting the light to display the first image; and
a transmissive pixel transmitting the light to display the second image.

9. The resistive type screen display apparatus of claim 8, wherein the first and the second images are different from each other.

10. The resistive type screen display apparatus of claim 8, wherein the first and the second images are substantially the same.

11. The resistive type screen display apparatus of claim 8, wherein the display panel part comprises:
an array substrate having the transmissive pixel and the reflective pixel;
a counter substrate having a common electrode facing the transmissive pixel and the reflective pixel; and
a liquid crystal layer disposed between the array substrate and the counter substrate.

12. The resistive type screen display apparatus of claim 11, wherein the light source part comprises:
a light source generating light; and
a light-guide plate facing the counter substrate and guiding the light to the counter substrate.

13. The resistive type screen display apparatus of claim 12, wherein the first electrode is disposed on a rear surface of the array substrate.

14. The resistive type screen display apparatus of claim 13, wherein the touch panel part further comprises a first polarizer having the second electrode disposed on a side facing the first electrode.

15. The resistive type screen display apparatus of claim 14, wherein the display panel part further comprises a second polarizer disposed between the counter substrate and the light-guide plate.

16. The resistive type screen display apparatus of claim 12, wherein the first electrode is disposed on the light-guide plate.

17. The resistive type screen display apparatus of claim 16, wherein the touch panel part further comprises a first polarizer having the second electrode disposed on a side facing the first electrode.

18. The resistive type screen display apparatus of claim 17, wherein the display panel part further comprises a second polarizer disposed on a rear surface of the array substrate.

19. A method of manufacturing a touch screen display apparatus comprising:
forming a resistive touch panel part including a first electrode, a second electrode facing the first electrode, and a porous polymer layer on a rear surface of an array substrate having a plurality of unit pixels, the porous polymer layer being disposed between the first and second electrodes for maintaining the distance between the first and second electrodes;
combining the array substrate and a counter substrate having a common electrode facing the unit pixels and interposing a liquid crystal layer between the array substrate and the counter substrate; and
assembling a light source part with the counter substrate.

20. The method of claim 19, wherein forming the touch panel part comprises:
forming the first electrode on the rear surface of the array substrate;
forming the porous polymer layer on the first electrode; and combining a first polarizer having the second electrode with the array substrate.

21. The method of claim 19, wherein forming the touch panel part comprises:
forming the first electrode on the rear surface of the array substrate;
forming the second electrode on a first polarizer;
forming the porous polymer layer on the second electrode; and
combining the first polarizer with the array substrate for the first and second electrodes to face each other.

22. The method of claim 19, further comprising combining a second polarizer with the counter substrate.

23. A method of manufacturing a touch screen display apparatus comprising:
forming a resistive touch panel part including a first electrode, a second electrode facing the first electrode, and a porous polymer layer on a light-guide plate, the porous polymer layer being disposed between the first and second electrodes for increasing the uniformity of distance between the first and second electrodes; and
combining the display panel part with the light-guide plate.

24. The method of claim 23, wherein forming the touch panel part comprises:
forming the first electrode on the light-guide plate;
forming the porous polymer layer on the first electrode; and
combining a first polarizer having the second electrode with the light-guide plate.

25. The method of claim 23, wherein forming the touch panel part comprises:
forming the first electrode on the light-guide plate;
forming the second electrode on a first polarizer;
forming the porous polymer layer on the second electrode; and
combining the first polarizer with the light-guide plate so that the first and second electrodes face each other.
